(19) United States
(12) Patent Application Publication
(10) Pub. No.: US 2007/0162248 A1
(43) Pub. Date: Jul. 12, 2007

(54) Optical system for detecting intruders

(76) Inventors: Larry C. Hardin, Brandon, OR (US); Larry V. Nash, Gold Beach, OR (US)

Correspondence Address: William O. Geny, Esq.;Chernooff, Vilhanue, McClung & Stenzel, LLP, Suite 1600, 601 SW Second Avenue, Portland, OR, 97204-3157, US

(21) Appl. No.: 11/702,832

(22) Filed: Feb. 5, 2007

Related U.S. Application Data
(63) Continuation-in-part of application No. 10/750,439, filed on Dec. 31, 2003.
Application No. 10/750,439 is a continuation-in-part of application No. 09/348,903, filed on Jul. 6, 1999, now Pat. No. 6,675,121.

(51) Int. Cl. G01P 11/00

(52) U.S. Cl. 702/142

(57) ABSTRACT

An intrusion detection system comprises a pair of optical lenses arranged a predetermined distance apart and having overlapping fields of view within an area to be monitored to form a common field of view; at least one light-sensitive device responsive to light from each of the optical lenses; a range detector responsive to signals from the light-sensitive device and operable to determine a range to an object within the common field of view; and a range discriminator for setting at least one range gate to sense objects within the common field of view at predetermined ranges and for ignoring objects outside of the predetermined ranges.

### CROSS-REFERENCE TO RELATED APPLICATIONS

This application is a continuation of application Ser. No. 10/750,439 filed Dec. 31, 2003, which was a continuation-in-part of application Ser. No. 09/348,903 filed Jul. 6, 1999.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

### Field of the Invention

Security systems frequently employ combinations of video monitoring and/or motion detectors that sense intrusion into an area. The former requires real-time surveillance by an operator while the latter is subject to frequent false alarm conditions.

U.S. Pat. No. 5,586,063 to Hardin et al., which is assigned to the assignee of this application and is incorporated herein by reference, is directed to a passive optical speed and distance measuring system (the '063 system). Specifically the '063 system includes a pair of camera lenses positioned along a common baseline a predetermined distance apart and controlled by an operator to capture images of a target at different times. The camera lenses are focused on light-sensitive pixel arrays that capture target images at offset positions in the line scans of the pixel arrays. A video signal processor with a computer determines the location of the offset positions and calculates the range to the target by solving the trigonometry of the triangle formed by the two camera lenses and the target.

With such a system, objects moving into the field of view of the video cameras may be monitored. Further if not only range but also direction and velocity were known, objects of interest could be tracked and others ignored. To some degree, this would alleviate the problem of false alarms.

### BRIEF SUMMARY OF THE INVENTION

An intrusion detection system comprises a pair of optical lenses arranged a predetermined distance apart and having overlapping fields of view within an area to be monitored to form a common field of view; at least one light-sensitive device responsive to light from each of the optical lenses; a range detector responsive to signals from the light-sensitive device and operable to determine a range to an object within the common field of view; and a range discriminator for setting at least one range gate to sense objects within the common field of view at predetermined ranges and for ignoring objects outside of the predetermined ranges.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a simplified block schematic diagram of the system of the invention.

FIG. 2 is a simplified flow chart diagram of a preferred embodiment of the present invention.

FIG. 3 is a schematic illustration of the electro optical relationships of the system used for generating a range measurement.

FIG. 4 is a schematic illustration of the electro optical relationships of the system used for generating a velocity measurement.

FIG. 5 is a schematic illustration of a simplified hypothetical example of the correlation process.

FIG. 6 is a null curve diagram illustrating an exemplary relationship between the shift in pixels (x-axis) and the sum of the absolute differences (y-axis).

FIG. 7 is a simplified schematic illustration depicting the angular relationships between camera A and the target T at times t₁ and t₂.

FIG. 8 is a simplified schematic illustration depicting the angular relationships between camera B and the target T at times t₁ and t₂.

FIG. 9 is a schematic illustration depicting the angular relationships used for generating velocity vector components and approximations.

FIG. 10 is a simplified schematic illustration depicting the angular relationships used for generating velocity vector components and approximations.

FIG. 11 is a simplified block schematic diagram of the system of the invention.

FIG. 12 is a simplified schematic illustration of a two-camera system of the present invention.

FIG. 13 is a simplified schematic illustration of a four-camera system of the present invention.

FIG. 14 is a simplified schematic illustration of a three-camera system of the present invention.

FIG. 15 is a depiction of the video scan lines orientation of the four-camera system of FIG. 13.

FIG. 16 is a schematic diagram illustrating the geometry of one of the optical detectors used in an intrusion detection system.

FIG. 17 is a schematic diagram illustrating the geometry of the intrusion detection system of FIG. 16.

FIG. 18 is a schematic diagram illustrating the range gate feature of the intrusion detection system.

FIG. 19 is a schematic diagram of one of the light-sensitive devices used for each of the lens in the intrusion detection system illustrating how objects are seen by the scanning of selected lines of pixels.

FIGS. 20A, 20B, and 20C are flow-chart diagrams illustrating the range gate setting feature of the intrusion detection system.

FIG. 21 is a schematic diagram of a lens and a light-sensitive element illustrating the geometry referred to in FIGS. 20A-20C.

FIG. 22 is a schematic diagram of a lens illustrating the vertical angular field of view of a line of pixels in a light-sensitive device.

FIG. 23 is a geometrical drawing illustrating the range span of a particular line of pixels in a light-sensitive device.

FIG. 24 is a geometrical line drawing illustrating minimum range of a selected line of pixels in a light-sensitive device as a function of object height.

FIGS. 25A and 25B are flow-chart diagrams illustrating how approaching/receding velocity discrimination is accomplished within a selected range gate.

### DETAILED DESCRIPTION OF PREFERRED EMBODIMENT

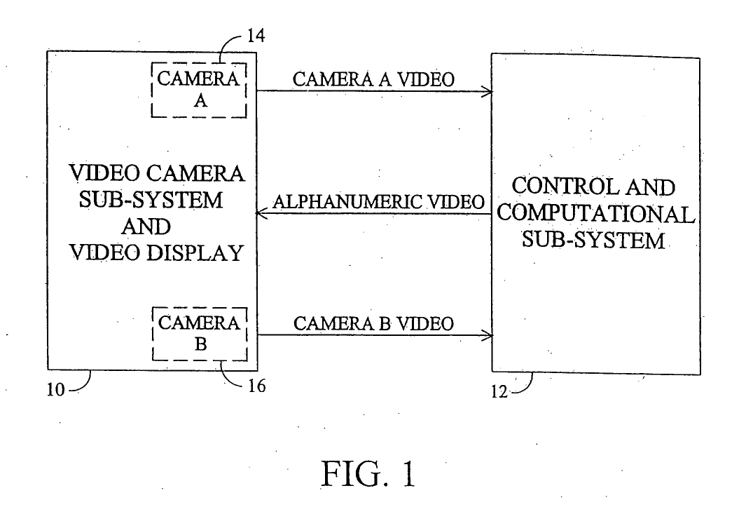

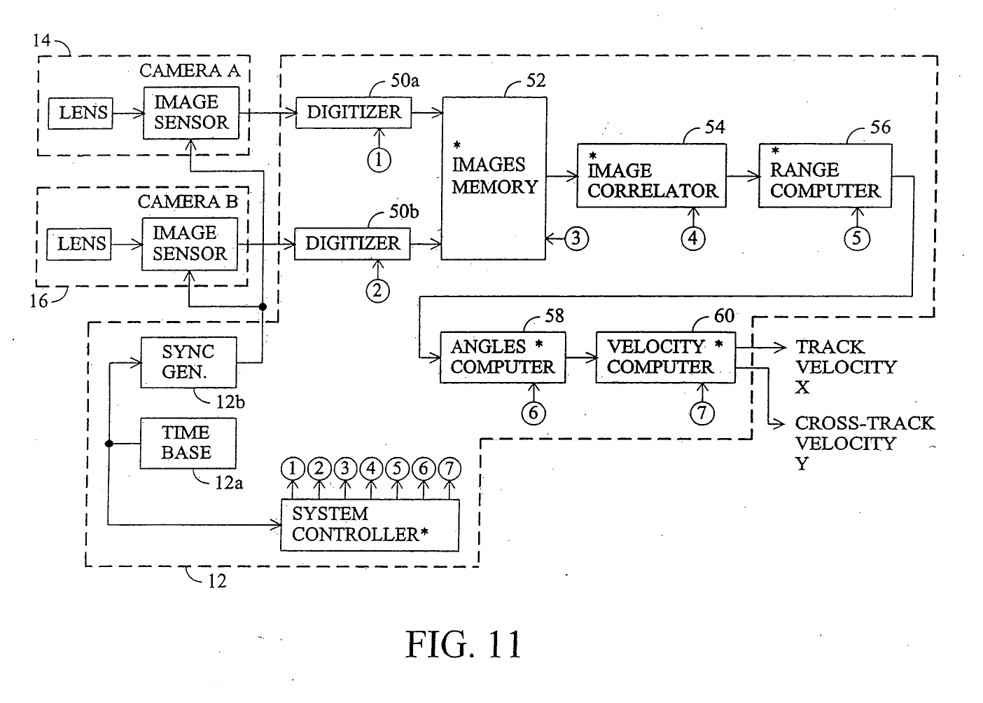

Referring to FIG. 1, the present invention includes a video camera subsystem and video display 10 connected to a control and computational subsystem 12. The camera subsystem 10 provides camera video from cameras A and B 14, 16 to the control and computational subsystem 12. The control subsystem supplies alphanumeric video to the video display subsystem 10. Cameras A and B 14, 16 may be any type of electro optical imaging sensors with a focal length f. Each imaging sensor can be, for example, a charge-coupled device (CCD), a charge-injection device (CID), a metal-oxide-semiconductor (MOS) phototransistor array or various types of infrared imaging sensors, one example of which is a Platinum Silicide (PtSi) detector array. Control and computational subsystem 12 may be any type of computer. For example, the computational subsystem 12 may be that shown in FIG. 11, a general-purpose computer with special software, or an alternate computer specifically designed to accomplish the functions described herein.

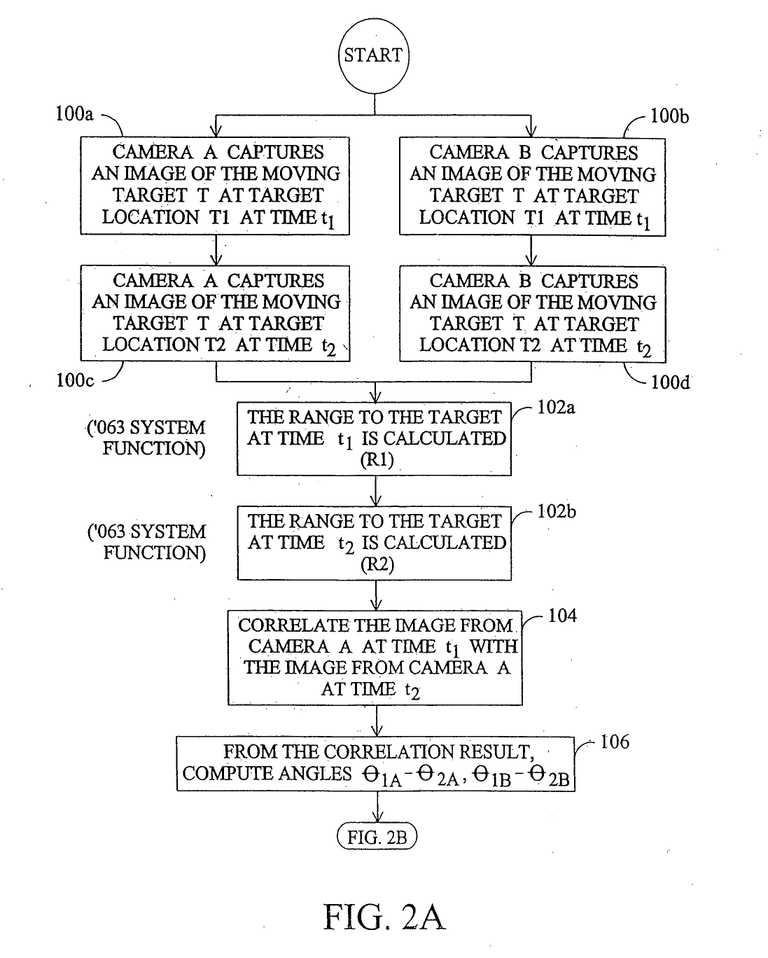

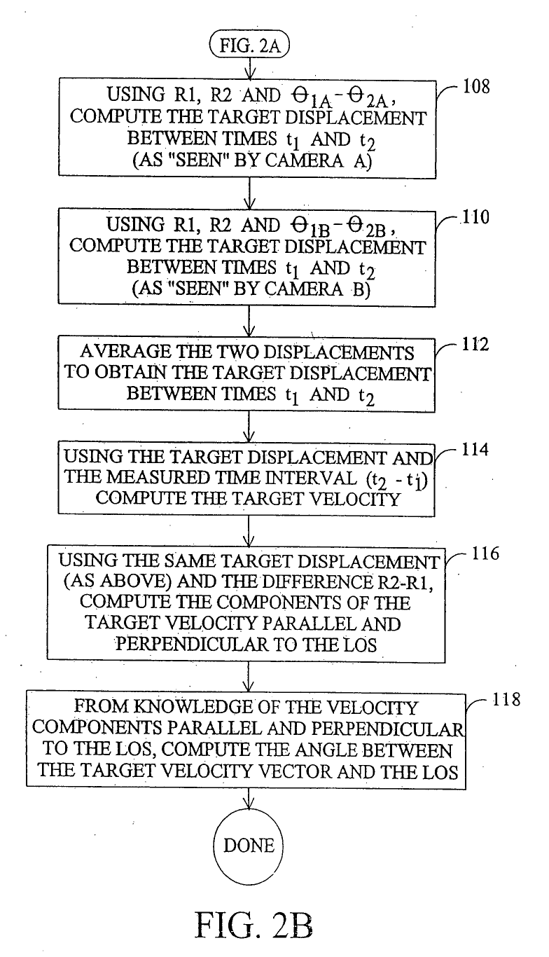

More specifically, as shown in FIG. 2, each of the cameras 14, 16 in the camera subsystem 10, when instructed by the control subsystem 12, take a video image or linear scan of moving target T at a first instance t₁ and at a second instance t₂ (for a total of four recorded images) 100a-100d. The target is at location T₁ at the first instance t₁ and at location T₂ at the second instance [t₂]. The camera subsystem 10 then passes the camera video to the computational subsystem 12 that makes the calculations necessary to determine the range of the target T at time instance t₁ 102a and the range R₂ of the target T at time instance t₂ 102b. As will be discussed below in detail, the ranges R₁ and R₂ to target T at both time instances t1 and t₂ are obtained by correlating the images obtained from both cameras at that time. The image from camera A at time t1 is then correlated with the image from camera A at time t₂ 104. From the correlation result, the angles θ_{1A}-θ_{2A} and θ_{1B}-θ_{2B} can be calculated 106. Using R₁, R₂, and the angle θ_{1A}-θ_{2A}, the target displacement between times t₁ and t₂ as seen by camera A 108 can be calculated. Using R₁, R₂ and the angle θ_{1B}-θ_{2B}, the target displacement between times t₁ and t₂ as seen by camera B can be calculated 110. The two displacements are then averaged to obtain the target displacement between times t₁ and t₂ 112. Then, the total target velocity V is calculated using the target displacement and the measured time interval (t₂-t₁) 114. Using the target displacement and the difference R₁- R₂, the components of the total target velocity parallel V_{X} and perpendicular V_{Y} to the line-of-sight can be computed 116. Finally, from the knowledge of the velocity components parallel and perpendicular to the line-of-sight, the angle between the total target velocity vector and the line-of-sight can be computed 118.

It should be noted that knowledge of the total target displacement δ_{R} and the time instance interval (t₂-t₁) enables computation of the velocity of the target as well as the components X_{R} and Y_{R} of the displacement vector δ_{R}. It should also be noted that the order of computations shown in FIG. 2 is meant to be exemplary and may be varied without changing the scope of the invention.

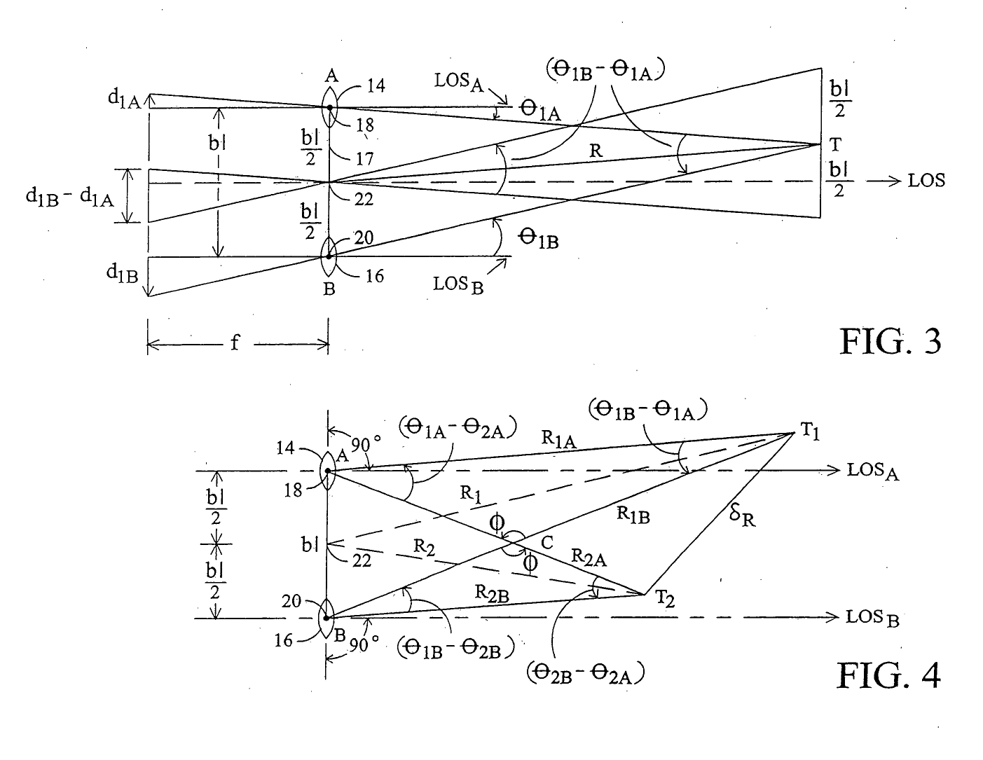

Turning first to the exemplary computation of range R, FIG. 3 shows an optical schematic diagram illustrating the placement of cameras A and B 14, 16 used in the method for measuring of the range R or distance from the center of a baseline 17 to the target T. The method for measuring range R, the first step in the method of the present invention, is substantially the same method as that used in the '063 system. Calculating R would be done twice in the method of the present invention: once for calculating R₁ (the distance from the baseline midpoint 22 to the target at location T₁) and once for calculating R₂ (the distance from the baseline midpoint 22 to the target at location T₂). R₁ and R₂ will be used as approximations for R_{1A}, R_{1B}, R_{2A}, and R_{2B} as set forth below.

Both the '063 system and the present invention, as shown in FIG. 3, include a camera A 14 positioned at a first position 18 and a camera B 16 positioned at a second position 20 on a baseline 17. In these positions, the cameras are separated by a distance of b1 [b₁] and have lines of sight LOS that are parallel and in the same plane. Range R, as measured by this method, is defined as the distance from the midpoint 22 of the baseline 17 to the exemplary target T. LOS is the line of sight of the two-sensor system. LOS_{A} and LOS_{B} are the lines of sight for cameras A and B 14, 16, respectively. LOS intersects baseline 17 at its midpoint 22, is in the same plane as the cameras' lines of sight, and is perpendicular to baseline 17. The angle shown as θ_{1A} is the angle between LOS_{A} and the target T and the angle shown as θ_{1B} is the angle between LOS_{B} and the target T. Using the image information supplied by the video camera sub system 10, the control and computational sub system 12 first determines the angle of interest (θ_{1B}-θ_{1A}) by electronically correlating the images from the focal planes of cameras A and B 14, 16 to measure the linear displacement d_{1B}-d_{1A}. The magnitude of d_{1B}-d_{1A} can be measured by correlating the A and B camera images obtained at time t₁. d_{1B}-d_{1A} is measured at the focal plane, which is behind the baseline, by a distance f, the focal length.

Image correlation is possible in the present invention because the system geometry (as shown in FIGS. 3 and 4) is such that a portion of the image from camera A 14 will contain information very similar to that contained in a portion of the image from camera B 16 when both images are acquired at the same time. This common information occurs in a different location in the camera A image when compared to its location in the camera B image due to the separation of the two cameras by the baseline distance b1.

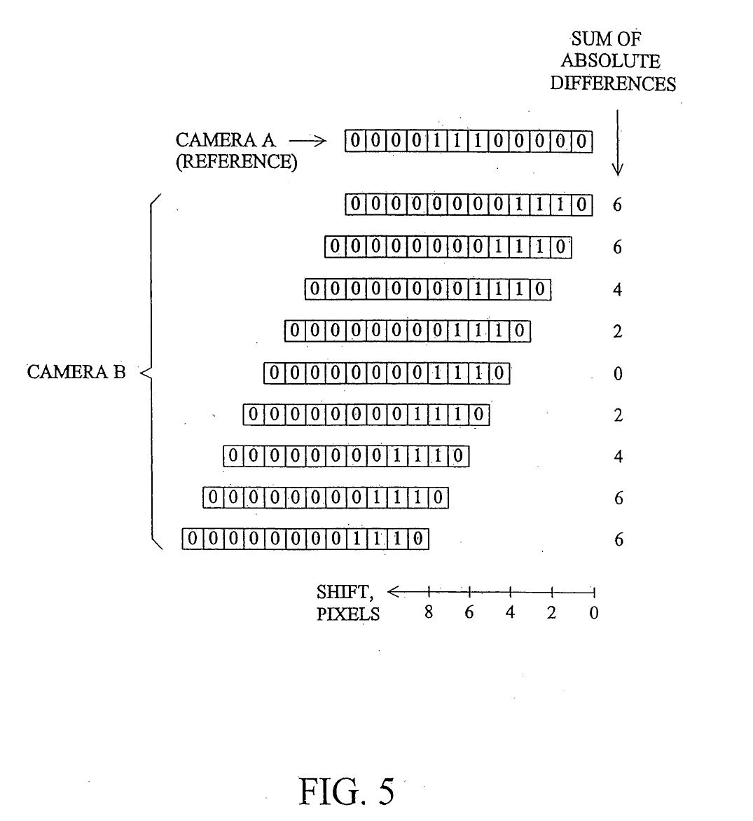

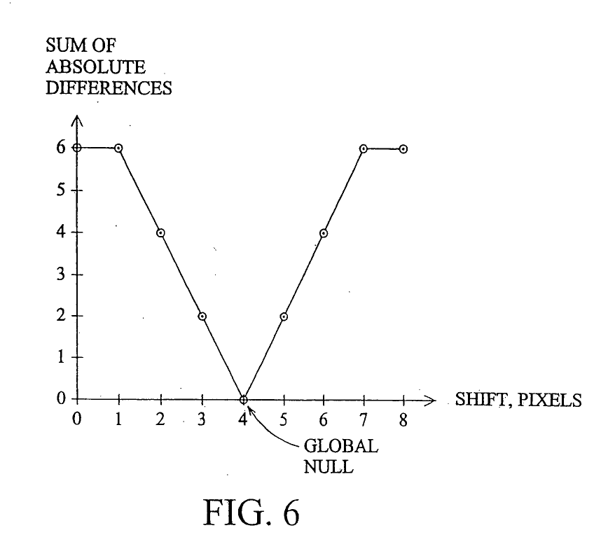

The correlation process is discussed in U.S. Pat. No. 5,586,063 to Hardin et al., which is assigned to the assignee of this application and is incorporated herein by reference. However, FIGS. 3 and 4 may be used to illustrate this process. FIG. 5 illustrates the correlation of two linear images, one from Camera A, the other from Camera B. For simplicity, a hypothetical video line of 12 pixels is shown. (In practice, cameras with video line-lengths of hundreds of pixels are used.) In addition, for simplicity of illustration, a single 3 pixel-wide image of unit (I) intensity is shown, with a uniform background of zero intensity. In practice, any pixel can have any value within the dynamic range of the camera. The pixel values for each of the two video lines are mapped in computer memory. In this case, the Camera A line is used as the reference. The map for the Camera B line is then matched with the A line map at different offsets from zero pixels to some maximum value dictated by other system parameters. (Zero pixels offset corresponds to a range of infinity.) This unidirectional process is sufficient since the relative position of any target in the FOV of one camera with respect to the other is known. At each offset position the absolute difference is computed for each adjacent pixel-pair that exists (the pixels in the overlap region). The differences are then summed. It should be noted that there are a number of other mathematical procedures that could be used to correlate the lines that would achieve similar results. One advantage of the procedure described is that no multiplication (or division) operations are required. (Addition and subtraction are computationally less intensive.) FIG. 6 is a plot of the sum of absolute differences (y-axis) versus the offset for this example. Note that the function has a minimum at the point of best correlation. This is referred to as the “global null,” “global” differentiating it from other shallower nulls that can result in practice. The offset value corresponding to the global null is shown in FIG. 6 as d_{1B}-d_{1A}. This quantity is also shown in FIG. 3.

In order to measure the total displacement of the target (in order to compute the total velocity) at least one more correlation is required. The additional correlation is performed in a similar manner to that described above, but is a temporal correlation. It uses images from the same camera (Camera A), obtained at two different times (t₁ and t₂). One difference is that the relative positions of the target image at the two different times are not known to the System. This requires that the correlation be bi-directional. Bi-directional correlation is achieved by first using the t₁ image map as the reference and shifting the t₂ image map, then swapping the image maps and repeating the process.

Once image correlation has been completed, the angle (θ1B-θ_{1A}) can be found from the equation: θ_{1B}-θ_{1A}=arctan [(d_{1B}- d_{1A})/f]. Using this information, range R is calculated by the equation: R=b1/[2 tan 2(θ_{1B}-θ_{1A})]. Alternatively, the computational sub-system 12 can find range R by solving the proportionality equation: (d_{1B}-d_{1A})/f=(b1/2)/R. The method for finding R is set forth in more complete terms in U.S. Pat. No. 5,586,063; however, alternative methods for computing range may be used.

FIG. 4 is an optical schematic diagram of the placement of cameras A and B 14, 16 as well as the angles and distances used in the method for measuring of the velocity v, the second step in the method of the present invention. To make the necessary calculations to find the velocity v, first the target displacement (δ_{R}) between the target location (T₁) at a first instance (t₁) and the target location(T₂) at a second instance (t₂) must be determined. Once δ_{R} is determined, the velocity (v) is computed as: v=δ_{R}/(t₂-t₁). It should be noted that the '063 system can compute only the ranges R₁ and R₂ which, when differenced (to form R₂-R₁), constitute only one component of the total displacement δ_{R}.

To find an accurate δ_{R}, both triangle A (defined by camera A lens 14 at position 18 on the baseline 17, the target location T₁ at the first instance t₁, and the target location T₂ at the second instance t₂) and triangle B (defined by camera B lens 16 at position 20 on the baseline 17, the target location T₁ at the first instance t₁, and the target location T₂ at the second instance t₂) should be solved. By solving triangle A to find δ_{RA}, an approximate of δ_{R} is found. Solving for δ_{RB} and averaging it with δ_{RA} (δ_{R}=(δ_{RA}+δ_{RB})/2) greatly reduces error in using a single calculation. It should be noted that images of the target acquired by cameras A and B at times t₁ and t₂ may have already been acquired and stored for use in range computations of the '063 system.

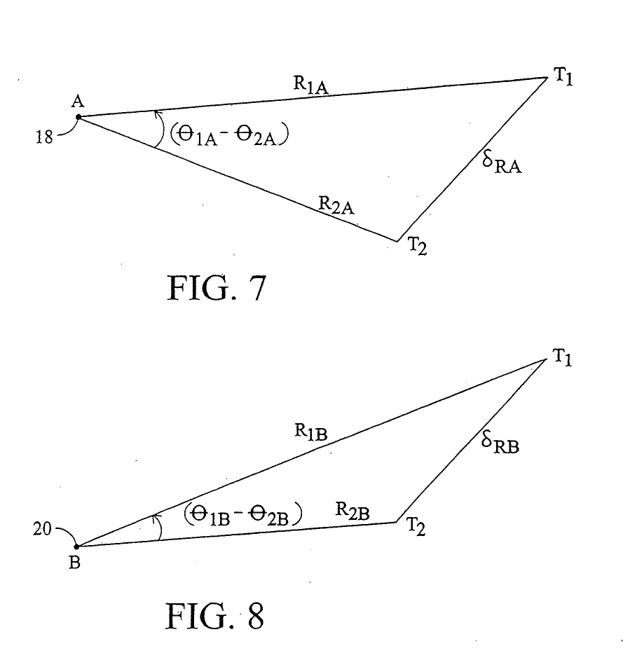

FIG. 7 shows an enhanced view of triangle A (defined by camera A lens 14 at position 18 on the baseline 17, the target location T₁ at the first instance t₁, and the target location T₂ at the second instance t₂). Specifically, the angle θ_{1A}-θ_{2A} is the angular difference between target locations T₁ and T₂, as measured by camera A. The images are acquired by camera A at times t₁ and t₂, as set forth above, and are then correlated to obtain the angle θ_{1A-θ}_{2A}. The next step is to use R₁ and R₂ as approximations for R_{1A} and R_{2A} respectively. R₁ and R₂ can be calculated using the equations set forth generally above and in detail in U.S. Pat. No. 5,586,063, incorporated herein by reference. Using these calculations, triangle A can be solved for the displacement δ_{RA}, using the law of cosines: δ_{RA}=[R₁₂+R₂₂−2_{R1R2} cos (θ_{1A}-θ_{2A})]½.

δ_{RA} is slightly different than the desired δ_{R} (of FIG. 4) because R₁ and R₂ are distances from the midpoint 22 of the baseline to target locations T₁ and T₂, whereas R_{1A} and R_{2A} are distances from camera A to target locations T₁ and T₂. Using the built in symmetry of the system, this error can be greatly reduced by solving triangle B (defined by camera B lens 16 at position 20 on the baseline, the target location T₁ at the first instance t₁, and the target location T₂ at the second instance t₂) of FIG. 8 for δ_{RB} and averaging the two results. δ_{RB} may be found using calculations similar to those set forth above for triangle A. Specifically, triangle B can be solved for the displacement δ_{RB}, using the law of cosines: δ_{RB}=[R₁₂+R₂₂−2_{R1R2} cos (θ_{1B}-θ_{2B})]½.

It should be noted that the solution of triangle B does not require a correlation operation (as did the solution of triangle A) to determine the angle θ_{1B}-θ_{2B}. The reason for this can be seen by referring to FIG. 4 where it can be seen that the triangles A, C, T₁ and B, C, T₂ both contain the same angle φ (from the law that opposite angles are equal). C is the point of intersection between R_{1B}, the range from camera B to the target at the first instance, and R_{2A}, the range from camera A to the target at the second instance.) Thus, since three of the four difference angles shown are known, the fourth can be computed using the law that the sum of the interior angles of a triangle is always equal to 180 degrees. Correlation using the images from camera B 16 may be performed for the optional purpose of verifying optical alignment.

As set forth above, once δ_{R} is determined, the velocity v of target T is computed as: v=δ_{R}/(t₂−t₁). The time base 12a and sync generator 12b (FIG. 11) would provide the elements necessary to compute t₁ and t₂.

The next step of the present invention is to compute the parallel component X_{R} of the displacement vector δ_{R} and the perpendicular component Y_{R} of the displacement vector δ_{R}. Component X_{R} of the displacement vector is parallel to the LOS in the plane defined by the LOS and the baseline 17. Component Y_{R} of the displacement vector is perpendicular to the LOS in the plane defined by the LOS and the baseline 17. The velocity vector components are determined by dividing the displacement vector component values by the time interval over which the displacement occurred.

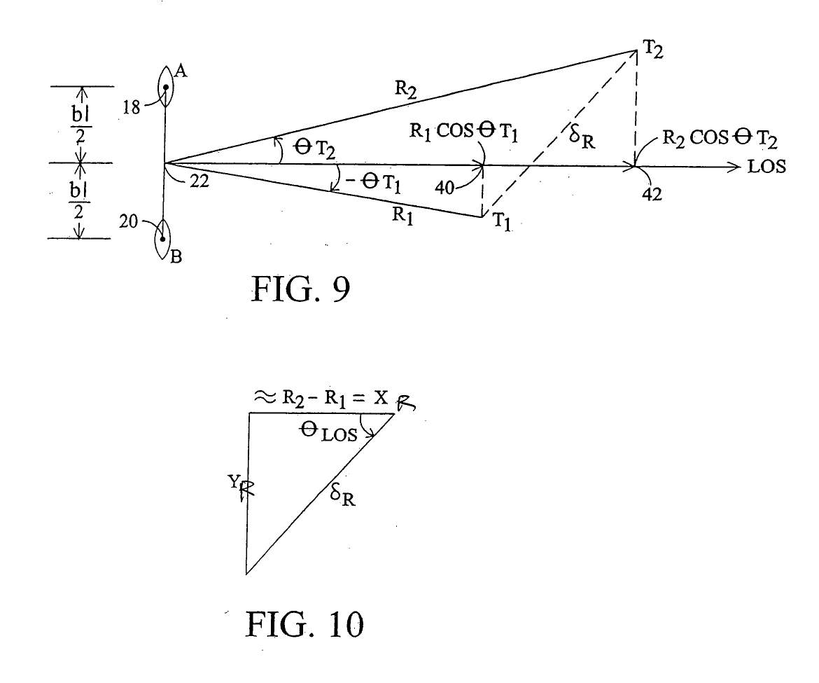

As shown in FIGS. 9 and 10, the x component parallel to the LOS, X_{R}, is defined as the difference of the two range measurements R₁ (the distance between the baseline midpoint 22 and the target T₁ at first instance t₁) and R₂ (the distance between the baseline midpoint 22 and the target T₂ at second instance t₂). The difference between the two range measurements can be approximately defined by the equation: X_{R}=R₂−R₁. This is an approximation, since the actual difference of the two range measurements is defined by the equation: R₂ cos θ_{T2}-R₁ cos θ_{T1}. R₁ c cos θ_{T1} is the distance on the LOS from the baseline midpoint 22 to point 40, the perpendicular distance from T₁ to the LOS. R₂ COS θ_{T2} is the distance on the LOS from the baseline midpoint 22 to point 42, the perpendicular distance from T₂ to the LOS. However, θ_{T2} (the angle between LOS and R₂) and θ_{T1} (the angle between LOS and R₁) cannot be determined. The X_{R}=R₂−R₁ approximation will produce accurate results when θ_{T1} and θ_{T2} are both small. V_{X}, the x component of the velocity vector, is then determined as V_{X}=X_{R}/(t₁-t₂).

The y component of the velocity vector, Y_{R}, also known as a “cross track” velocity component, is then solved using the relationship set forth in FIG. 10. Using δ_{R} (as computed above) as the hypotenuse and X_{R} (as computed above) as one leg of the relationship triangle of FIG. 10, the triangle shown in FIG. 10 can be solved for the perpendicular displacement component Y_{R} using Pythagorean theorem: Y_{R}=[(δ_{R})²-X_{R}²]^{1/2}. The y component of the velocity, V_{Y}, is then V_{Y}=Y_{R}/t₂₋t₁. The angle between the velocity vector and the LOS can then be calculated by the following equation: θ_{LOS}=arctan Y_{R}/X_{R}. Knowledge of the angle θ_{LOS} is of value in applications where it is desirable to move the system line-of-sight to track the target or simply to keep the target in the field of view.

FIG. 11 shows an exemplary functional block diagram of one possible implementation of the velocity measuring system of the present invention. Camera or sensor A 14 and camera or sensor B 16 are electronic imaging cameras substantially controlled by the system controller 12. The time base 12a and sync generator 12b are used to synchronize the cameras. Further, the time base 12a provides the time interval measurement capability that allows calculation of t₁ and t₂. The time between image acquisitions may be determined by keeping count of the number of camera images that have been scanned between image acquisitions.

The digitizers 50a, 50b convert the analog camera outputs to a digital format, enabling the camera images (or portions thereof) to be stored in conventional computer type memory 52.

The image correlator 54 correlates the images supplied by camera A 14 and camera B 16. The correlation process is used to determine the angular difference between cameras when sighting an object or target T at the same time (“correlation”) or at two different times (“cross correlation”).

The range computer 56 then determines the range R to the target T by triangulation using the measured angular difference acquired by the cameras at the same time.

The angles computer 58 uses both the range and angle measurements to compute the components of displacement of the target T parallel and perpendicular to the system LOS.

The velocity computer 60 uses the measured displacement components and knowledge of the time between measurements (t₂-t₁) to compute velocity V and its components, V_{X} and V_{Y}.

The system controller 12 sequences and manages measurement and computation. The image correlator 54, range computer 56, angles computer 58, velocity computer 60, and system controller 12 can be implemented as hard-wired electronic circuits, or a general-purpose digital computer with special software can perform these functions.

Although the invention has been described with reference to detection systems for detecting the range and total velocity of a general moving target it should be understood that the invention described herein has much broader application, and in fact may be used to detect the range to a stationary object, the total velocity of any moving object and/or relative motion between moving or stationary objects. For example, the invention may be incorporated into a range and velocity detection system for moving vehicles. Another example is that the invention may be incorporated in a robotics manufacturing or monitoring system for monitoring or operating upon objects moving along an assembly line. Still another important application is a ranging device used in conjunction with a weapons system for acquiring and tracking a target. Yet another application is a spotting system used to detect camouflaged objects that may be in motion against a static background. Other possible uses and applications will be apparent to those skilled in the art.

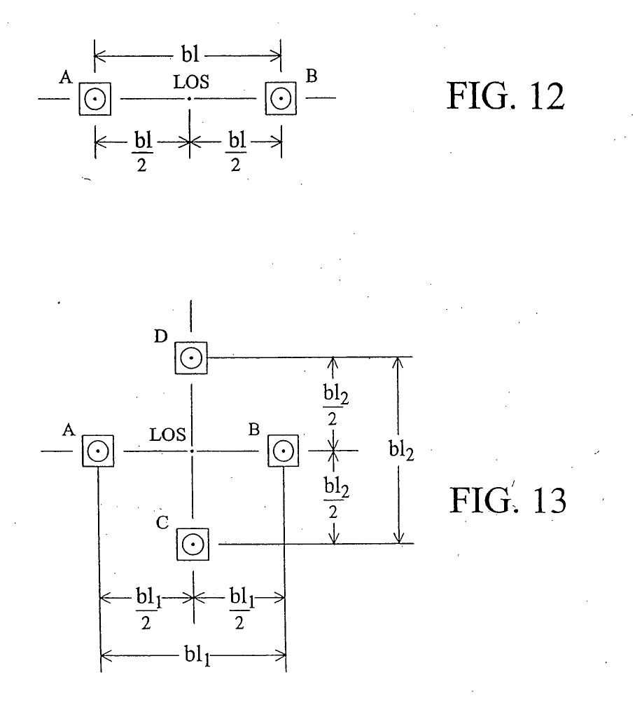

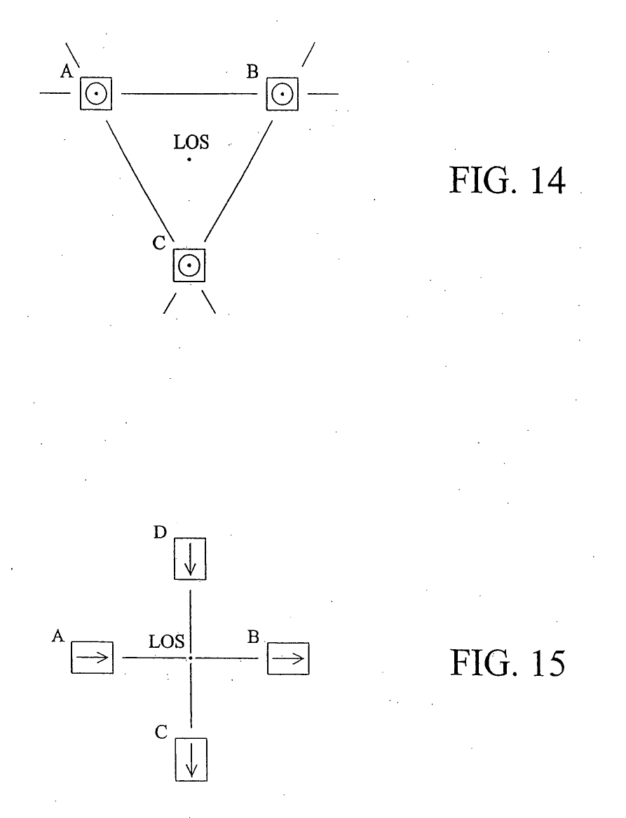

The foregoing invention can also be adapted to measure velocity in three-dimensional space. To do this a two-dimensional camera configuration, such as that shown in FIG. 12, is adapted to either the configuration shown in FIG. 13 or FIG. 14. The embodiment shown in FIG. 13 uses four cameras, A, B, C, and D centered around a central LOS (extending outward form the page). The baseline b11 defined between cameras A and B is perpendicular to baseline b12 defined between cameras C and D, although b11 and b12 need not be the same length. FIG. 15 shows the video scan lines orientation for this system in which cameras A and B operate as one subsystem and cameras C and D operate as a second subsystem that is a duplicate of the camera A and B subsystem, except for its orientation. The velocity vectors produced by the two subsystems are summed (vector summation) to yield the total target velocity in three dimensions. FIG. 14 shows an alternate configuration that can measure velocity in three-dimensions, but uses only three cameras A, B, and C. It should be noted that the FOV is smaller than that of the four-camera system of FIG. 13 and the calculations to determine the velocity are more complex.

The velocity measuring system of the preferred embodiment can be adapted as an intrusion detection system. Although many intrusion detection systems use video surveillance cameras as monitors, attempts to make such systems automatic are problematic. Passive optical systems “see” everything and are therefore triggered by numerous false alarms. Falling objects, birds, animals and other objects that are not of interest are detected by such systems in the same way that intruders are. In the simplest system of this type, a video camera scans an area and continuously compares a scan of the pixels of a light-sensitive device with a previous scan. When the pixel maps are compared, any difference between a present scan and previous scan means that an object has moved into the field of view and thus, an alarm is triggered.

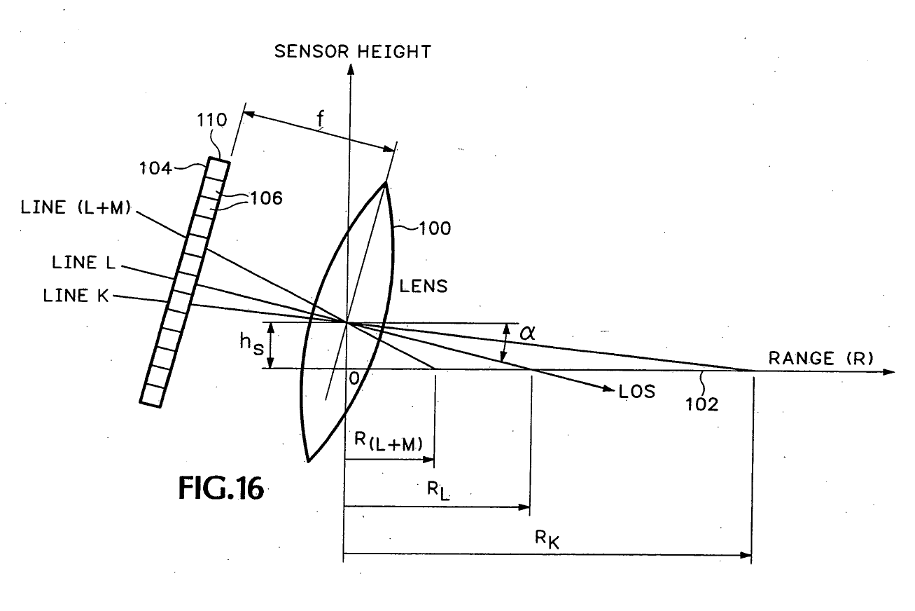

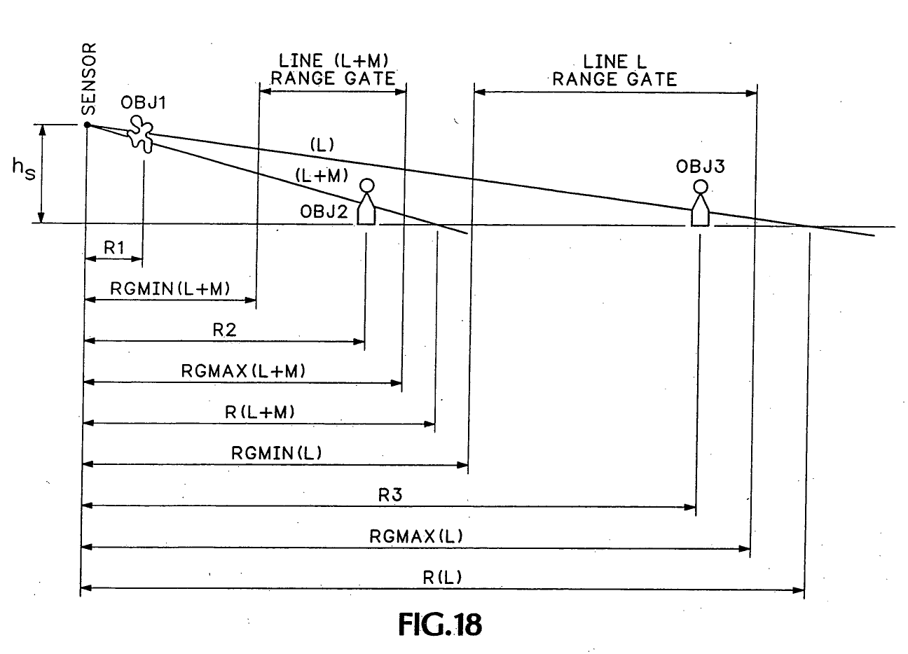

In order to prevent false alarms, a passive optical system must be capable of discrimination between objects of interest such as human intruders and other objects. These objects can be detected by discriminating between various objects in the field-of-view of the system on several bases. First, the system may be configured to respond only to objects located at a given range within the area to be monitored. As will be explained below, a range gate may be set so that only objects captured within the range gate are recorded on the system; all other objects are ignored. Discrimination may also occur on the basis of the object's height and its velocity. Because velocity is a vector quantity as explained above, discrimination may also occur on the basis of the algebraic sign of the velocity vector. The system employs the same setup as illustrated in FIG. 1. However for intrusion detection, it is best to mount the system at a height h_{S} above the ground as shown generally in FIG. 18. Having the system pointed downward at an obtuse angle to ground reference will provide the range gate capability required for object discrimination. A schematic close-up of this configuration is shown in FIG. 16 in which a lens 100 is mounted at a height h_{S} above a horizontal surface 102, which may be the ground or a floor but is some horizontal reference plane. The lens has a focal length f and a light-sensitive device, such as a charge coupled device or equivalent 104, is placed at the focal length. The light-sensitive device 104 includes a plurality of lines of pixels 106. A pair of lenses, such as lens 100 which may be associated with video cameras 14 and 16, are placed at a downward looking angle a predetermined distance apart. Usually, the baseline distance between the two lenses will be parallel to the horizontal surface 102. This is not absolutely necessary as the geometry can be corrected if the baseline between the lenses is not perfectly horizontal. Each lens includes a light-sensitive device 104. This may be a charge coupled device or any similar device having photosensitive elements as described above.

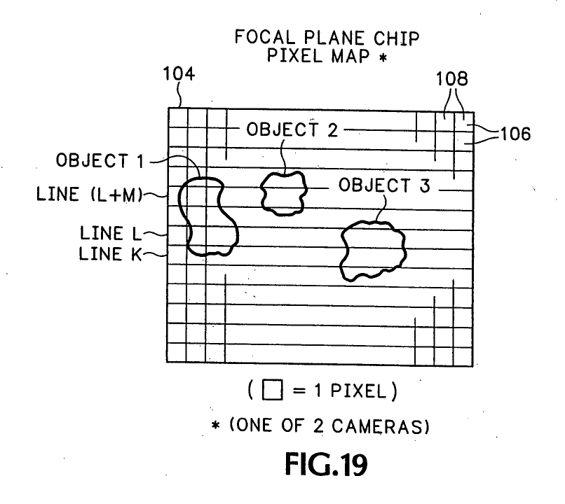

Referring to FIG. 19, the light-sensitive device 104 includes lines 106 comprised of individual pixel elements 108. While FIG. 16 shows the use of a light-sensitive device 104 for each of the lenses represented by lens 100 in FIG. 16, it should be understood that a single light-sensitive device may be used if desired. Light from each of the lenses can be routed to a single light-sensitive device using mirrors and the like. However, simplicity of construction makes it more practical to use a single light-sensitive device for each lens in the dual lens array.

The light-sensitive device, typically a charge-coupled device or a CMOS imager chip, is in the focal plane of the lens; f is the focal length of the lens 100. The light-sensitive device 104 is shown for clarity of illustration as having only a few lines of pixels 106. However, an actual chip of this type would have hundreds of lines. From FIG. 16, it can be seen that for the particular orientation chosen, that is, the angle at which the lens is pointed into the space to be monitored, each line 106 on the chip “sees” out to a different maximum range. For example, line L is sensitive to objects at range R_{L} but no further. The topmost line of the chip, line 1 10, would define the minimum range whereas ordinarily the bottom line 112 would define the maximum range. The maximum and minimum ranges are determined by the focal length f of the lens, the height h_{S} of the system above the ground 102, and the elevation angle α.

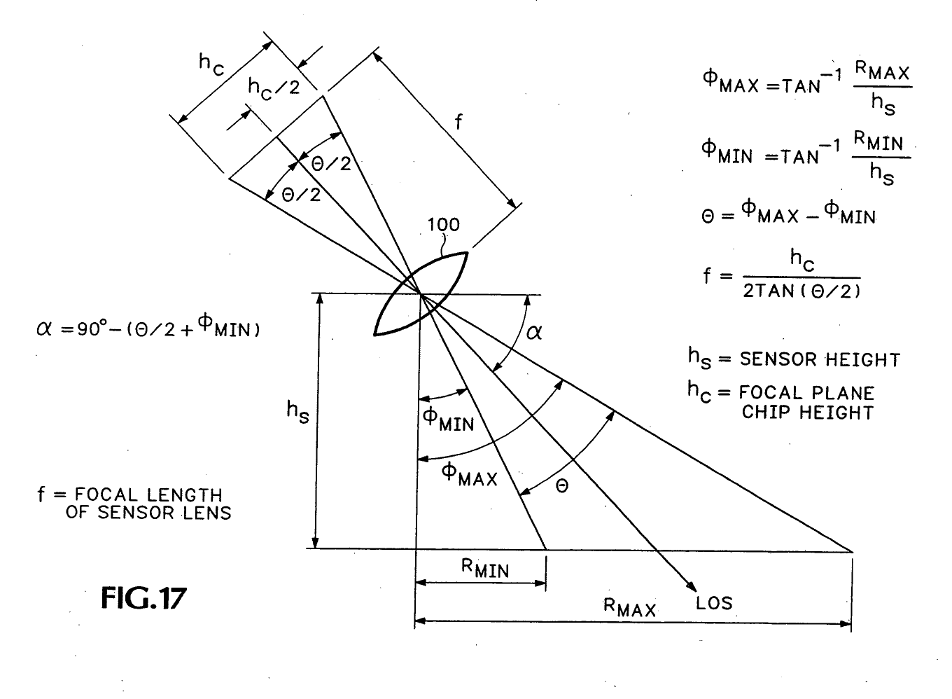

Referring to FIG. 17, the system is set up by selecting the desired maximum range Rₘₐₓ and the minimum range Rₘᵢₙ and the sensor height h_{S}. Once this is done, the angles Φₘₐₓ and Φₘᵢₙ can be calculated and the field-of-view angle (angle θ) may then be determined. The elevation angle α to which the system must be set can then be computed as a function of θ and Φₘᵢₙ. Once this is done, the only remaining task is to compute the focal length necessary for the lens. This focal length is a function of θ and the focal plane imager chip height h_{C}. The five necessary equations for solving for the focal length f are as follows:
Φₘₐₓ=arctan (Rₘₐₓ/h_{S}) Eq. 1
Φₘᵢₙ=arctan (Rₘᵢₙ/h_{Ss}) Eq. 2
θ=Φₘₐₓ−Φₘᵢₙ Eq. 3
α=90 deg. −(θ/2)−Φₘᵢₙ Eq. 4
f=h_{C}/[2 tan (θ/2)] Eq. 5

One mode of the intrusion sensing operation is shown in FIG. 18. FIG. 18 shows how the use of a range gate enables a system to discriminate between objects of interest and false alarms. A range span within which objects will be detected by correlation of a specific video line pair can be established by the control and computational subsystem of FIG. 11. The maximum range in the span cannot be greater than the maximum range that the specific line can “see.” However, it can be less. The minimum range of the range span can be any range less than the maximum. Once this span or “range gate” is set, the video line pair correlation is restricted to this span of distance within the area to be monitored. In FIG. 18, two range gates are shown, one for video line pair L and one for line pair L+m.

Line L can see both object 1 and object 3 but only object 3 is within the line L range gate. Line L+M can also see object 1. In addition, line L+M can see object 2 but only object 2 is in the line L+M range gate. Thus, if object 1 were an object blown by the wind or a bird, it would be seen by many of the video lines in the light-sensitive device but it would not cause a false alarm because the range, when calculated, falls outside the parameters for the range gate of either line L or line L+M. The way in which the objects 1, 2, and 3 might be seen by the light-sensitive device 104 is illustrated in FIG. 19. It should be noted that in order to perform object detection within a predetermined range gate, line pair correlation is performed for only a limited plurality of pixel lines 106 of the light-sensitive device 104. In effect, the light-sensitive device may be separated into pixel line “zones” which represent various range gates. Thus within an area to be monitored, range gates may be set at both distant and near ranges as determined by the needs of the user.

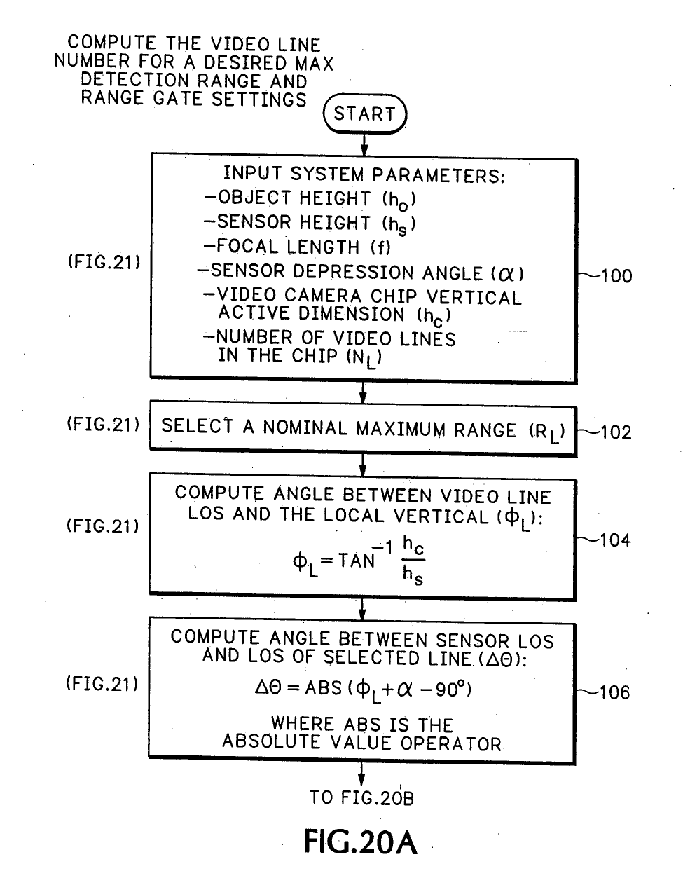

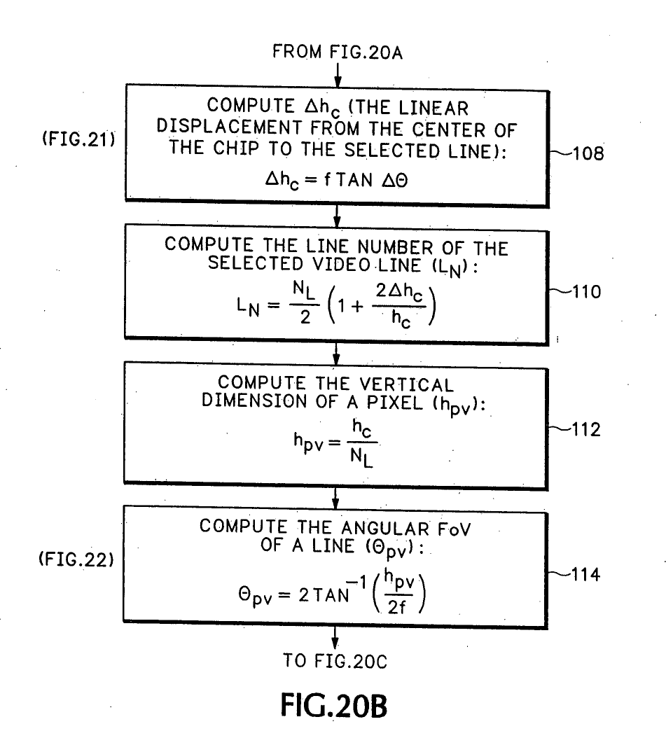

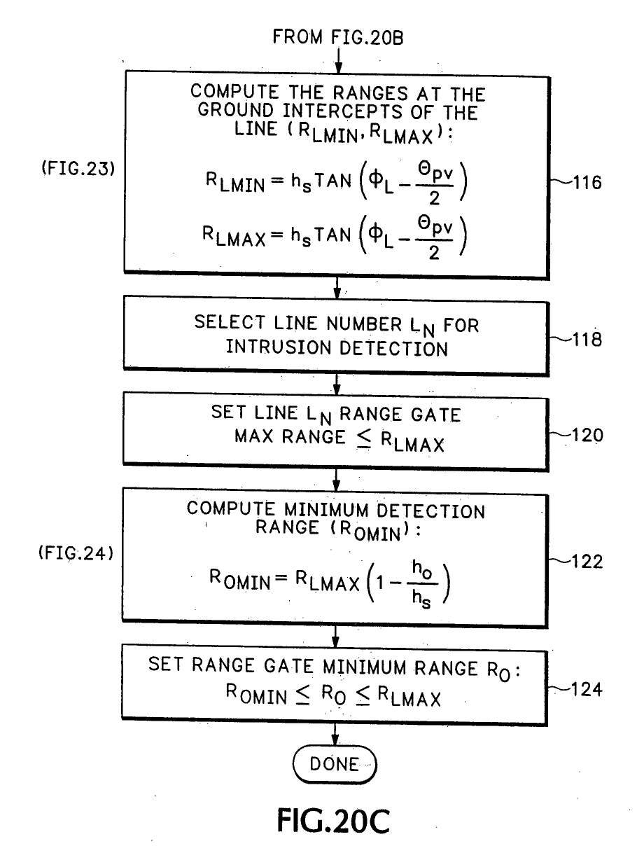

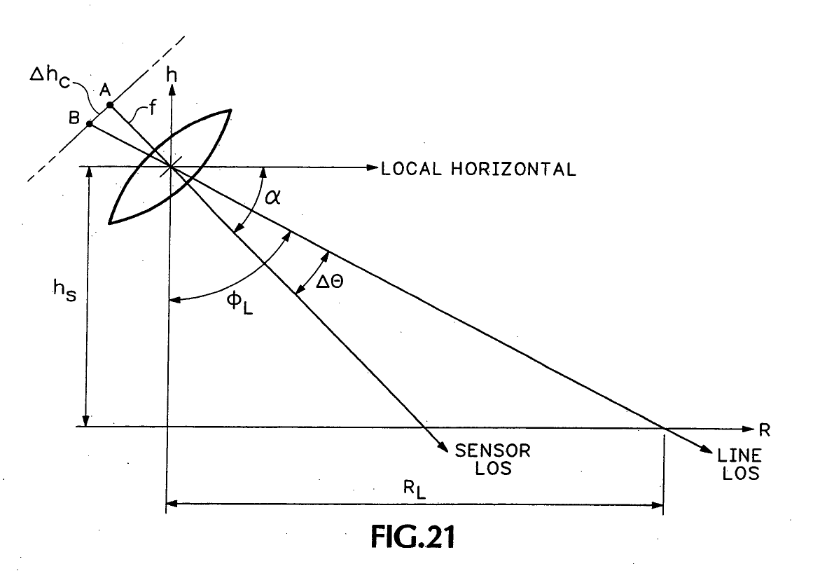

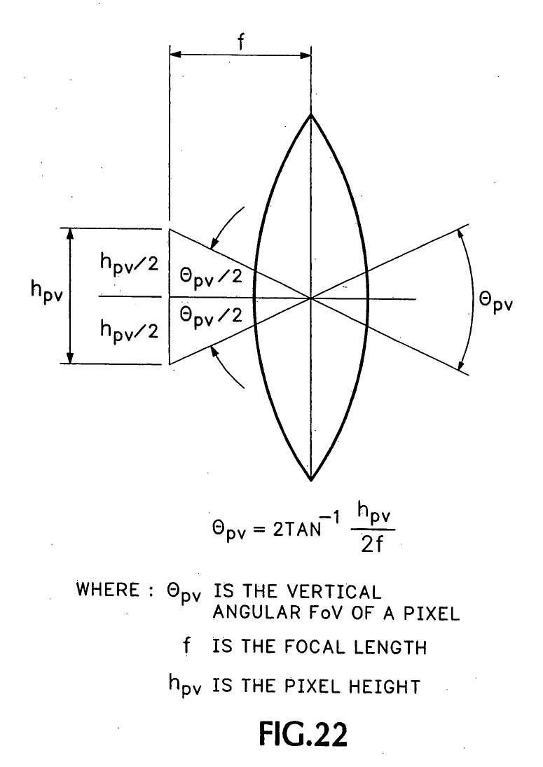

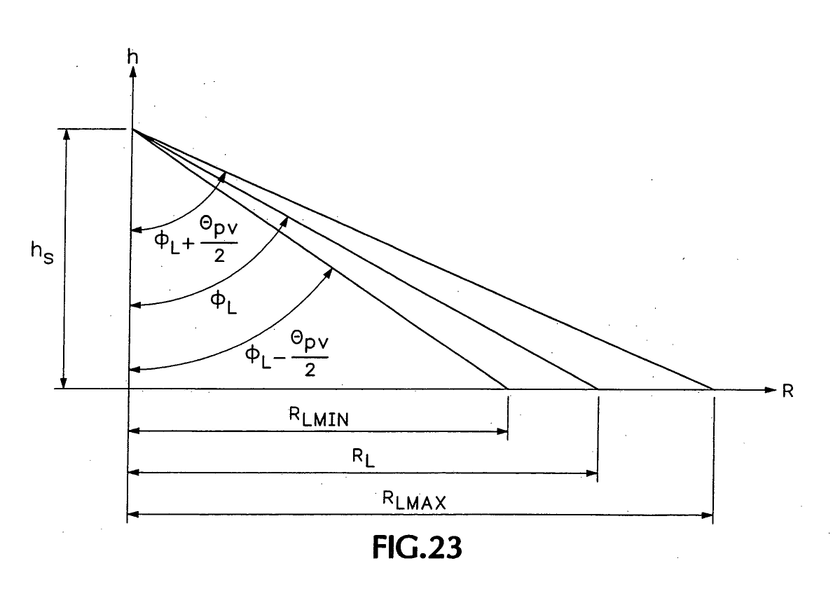

FIGS. 20A-20C illustrate the method by which the range gate is selected by the system controller of FIG. 11. FIGS. 20A-20C are a flowchart diagram that illustrates how the range gate is set. Once the system is installed within an area, a number of parameters must be set. These parameters may be measured and entered into the system through a computer keyboard. At block 100, object height, sensor height, focal length, sensor depression angle, the video camera chip vertical active dimension and the number of the video lines in the chip are all entered into the system. Next, a nominal maximum range is selected at block 102. This range will depend upon the dimensions of the area to be monitored. At block 104, the angle Φ_{L} is computed, which is the angle between video line-of-sight and a local vertical reference (which is ninety degrees (90°) to local horizontal). At block 106, the angle is computed between the sensor line-of-sight and the line-of-sight that will be seen by a pixel line at the maximum range. Note that the identity of this pixel line is not yet known; it will be computed. Next, the linear distance or displacement from the center of the chip to the line which sees out to the maximum range is computed in block 108. From this computation, the line number can then be computed in block 110. Once the line number is known, the vertical dimension of the pixel can be computed as shown in block 112. From this information, the angular field of view of any particular line can be determined in block 114. Referring to FIG. 20C, now the ranges at the horizontal reference intercepts of any particular line may be computed. These parameters are shown graphically in FIG. 23. In block 118, the system next selects a line number for intrusion detection and in block 120, with the information previously known for each line number, the maximum dimension of the range gate is set.

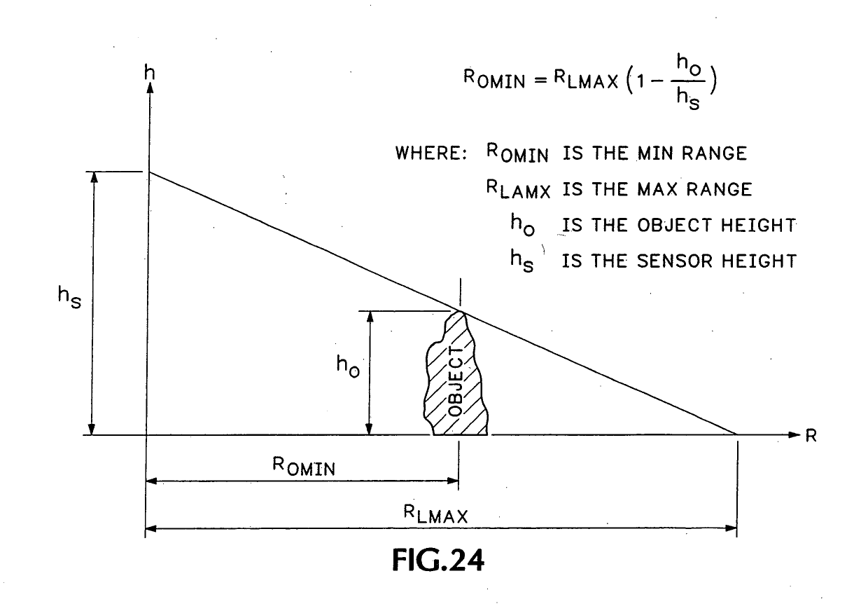

Referring to FIG. 24, some assumptions must be made about the size of objects that will be seen by the system when they are found within the distance limits defined by the range gates. In FIG. 24, an object has a height Ho. This dimension is then inserted in block 122 into the system so that the minimum range gate distance R_{O min} may be calculated. Referring to block 124, the range gate minimum can now be set so that the intrusion detection system is configured to see objects that appear between the distances within the area to be monitored between R_{O min} and R_{L max}. As an example, given nominal system parameters of H_{S} as 10 feet (that is the two lenses and light-sensitive elements, preferably in the form of a pair of video cameras are placed 10 feet above the horizontal reference ground at a nominal angle of between one and two degrees pointing downward) with a focal length of a 159 millimeters and a chip height of 0.25 inches with 525 lines of pixels, if the maximum range is set to 500 feet and the object height of interest is set to six feet, the system would use video line number 383 for detection. Line number 383 would see out to a maximum range of about 500 feet and to a minimum distance of about 200 feet. This would then avoid false alarms from objects that are higher than six feet but which occur at a range of less than 200 feet. This is merely an example, however, and the parameters of the system can be set by the user to define a single range gate, or multiple range gates, according to its particular needs.

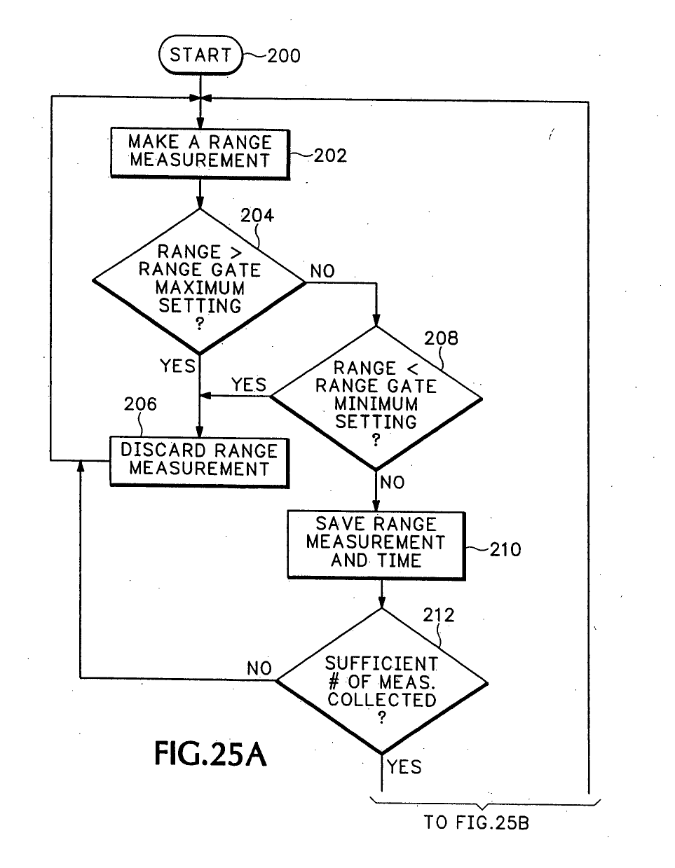

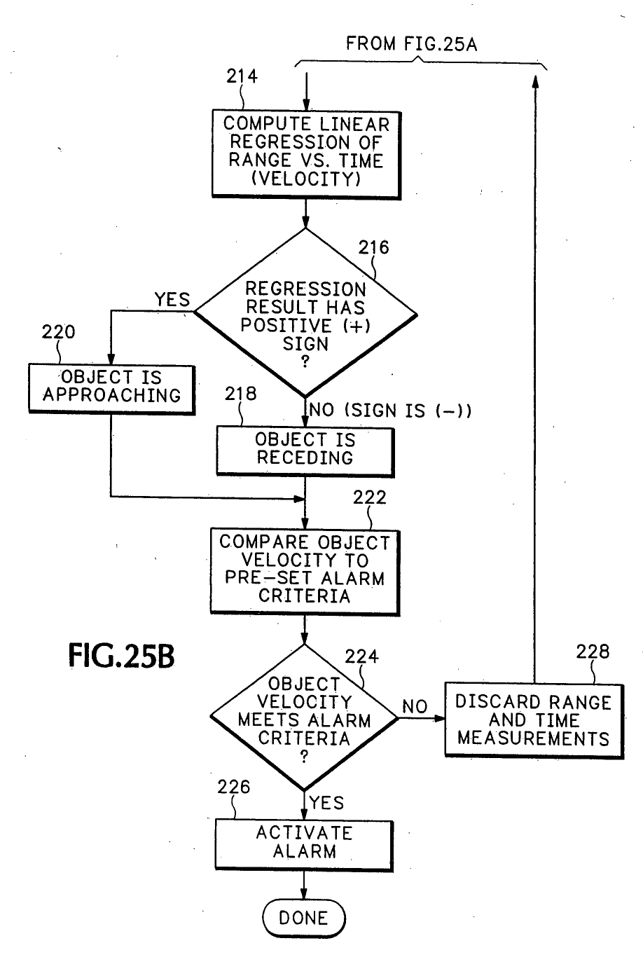

Referring to FIGS. 25A and 25B, a block diagram is shown which illustrates how the system of FIG. 11 operates to detect intruders within a secured area. Referring to FIG. 25A, after power-up and start at block 200, the system makes a range measurement (block 202). If the range detected is greater than the range gate maximum setting (block 204), the range measurement is discarded (block 206). The program loops back and another range measurement is made. If the range is not greater than the maximum setting in block 204, the measurement is compared with the range gate minimum setting (block 208). If the measurement is less than the minimum setting, the measurement is discarded (block 206). If the measurement is not greater than the minimum setting, the measurement is saved and the time is noted (block 210). This process continues until a sufficient number of measurements are collected (block 212). Once a sufficient number of data points have been collected, a linear regression of range versus time is computed (block 214). This computation yields the velocity of an object of interest that is found within the range gate. The system then determines whether the velocity is positive or negative (block 216). If negative, the object is marked as one that is receding (block 218). If positive, the object is approaching as determined in block 220. The system controller of FIG. 11 may contain preset alarm criteria. This provides still further discrimination among objects of potential interest. For example, objects that are moving either too fast (i.e., birds or falling objects) or objects that move too slowly may be eliminated. In block 222, a comparison is made between the objects velocity and preset alarm criteria. If the velocity criteria is met (block 224), an alarm is activated (block 226). On the other hand, if the object velocity does not meet the preset alarm criteria, it may be discarded (block 228).

Thus, the intrusion detection system of the preferred embodiment is able to discriminate among objects not only on the basis of their range but also based upon velocity within a range of interest. Other criteria may be imposed as well. For example, objects approaching (positive velocity vector) at a high velocity might be discarded while objects receding at a similar velocity might be deemed to be of interest, or vice-versa. The user may select parameters based upon the particular environment to be monitored.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. An intrusion detection system comprising:
(a) a pair of optical lenses arranged a predetermined distance apart and at a predetermined height above a ground reference plane and having overlapping fields of view within an area to be monitored to form a common field of view, said pair of lenses being tilted in a downward direction toward said ground reference plane;
(b) at least one light-sensitive device responsive to light from said pair of optical lenses and having an output signal;
(c) a range discriminator for setting at least one range gate defining maximum and minimum predetermined ranges so that said light-sensitive device is configured to sense objects within said common field of view within said maximum and minimum predetermined ranges and to ignore objects that appear outside of said predetermined ranges;
(d) a range detector responsive to said output signal from said light-sensitive device operable to determine the range to any object within said common field of view and within said predetermined ranges.

2. The intrusion detection system of claim 1 further including a velocity detector responsive to said output signal at two different times for determining the velocity of an object moving within said predetermined ranges.

3. The intrusion detection system of claim 1 wherein said optical lens has a light-sensitive device.
